(19) United States
(12) Patent Application Publication
(10) Pub. No.: US 2012/0249101 A1
(43) Pub. Date: Oct. 4, 2012

(54) CONSISTENTLY BALANCED THERMAL LOAD DC-DC CONVERTER

(76) Inventor: David W. Akey, Olympia, WA (US)

(21) Appl. No.: 13/078,228

(22) Filed: Apr. 1, 2011

(51) Int. Cl. G05F 1/567

(52) U.S. Cl. 323/272

(57) ABSTRACT

A consistently balanced thermal load switched mode converter alternates among all phases of the power switching circuit to provide a uniform temperature rise on all components of the circuit under all load conditions. During low load conditions typically phases are held idle and the load is concentrated on the active phase(s) only, with cooling requirements (air flow, etc.) based on the temperature of the active phase(s). By alternating the active phases in a balanced sequence the thermal load is distributed across all of the phases minimizing system cooling requirements under all load conditions.

### FIELD OF THE INVENTION

Embodiments of the present invention are directed to power converters and, more particularly, to thermally balanced DC-DC converters.

### BACKGROUND INFORMATION

Direct Current to Direct Current (DC-DC) converters are able to convert energy from a power supply from one voltage and current level to another voltage and current level. DC-DC converters are utilized in conjunction with various computing systems such as desktop, servers, and home electronics. DC-DC converters may also be found in mobile computer systems such as laptops, mobile phones, personal digital assistants, tablets, and gaming systems.

Today's microprocessors may consume 100-200 Watts of power. A DC-DC converter may be used to provide power to a processor that requires low voltages, such as 0.5 to 2.0 volts (V), and high currents, such as 100 amperes (A) or more. Further, the current demands of processors may change over a relatively wide range with a relatively high slew rate.

Multiphase DC-DC converters may be used to provide the high-current low-voltage demands of computing systems. Today's multiphase DC-DC converters may use discrete-inductor topologies, which require large filter capacitances and may not be suitable for monolithic integration. Other multiphase DC-DC converters may include multiphase transformer topologies that fail to maximize the efficiency of the DC-DC converter. Also, such multiphase DC-DC converters fail to take into account the order that phases are assigned to the multiphase transformer.

A particular computing system has different power demands that fluctuate based on the particular tasks it is currently performing. The computing system generally generates heat which must be dissipated with the more power its consuming, the more heat it is generating. However, the DC-DC converter itself also creates a source of heat that must be dissipated.

Conventionally, during high load conditions, all of the phases of a multiphase converter operate to supply power to the system. As load requirements decrease fixed phases may be switched off to conserve power. However, this solution tends to concentrate the thermal load in the remaining fewer operating phases leading to an unbalanced thermal condition.

### BRIEF DESCRIPTION OF THE DRAWINGS

The foregoing and a better understanding of the present invention may become apparent from the following detailed description of arrangements and example embodiments and the claims when read in connection with the accompanying drawings, all forming a part of the disclosure of this invention. While the foregoing and following written and illustrated disclosure focuses on disclosing arrangements and example embodiments of the invention, it should be clearly understood that the same is by way of illustration and example only and the invention is not limited thereto.

FIG. 1 is a block diagram of a multiphase pulse width modulation (PWM) power converter according to one embodiment of the invention;

FIG. 2 is a timing diagram showing thermal load distribution across the various phases during various load conditions; and

FIG. 3 is an example computing system which may use the multiphase pulse width modulation (PWM) power converter according to one embodiment of the invention.

### DETAILED DESCRIPTION

Described are power deliver systems which, unlike current multiphase power converters, where fixed phases are switched off to save power concentrating the thermal load on fewer phase(s), embodiments of the invention alternate the active phases and thereby shares the thermal load reducing peak temperature on all phases.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

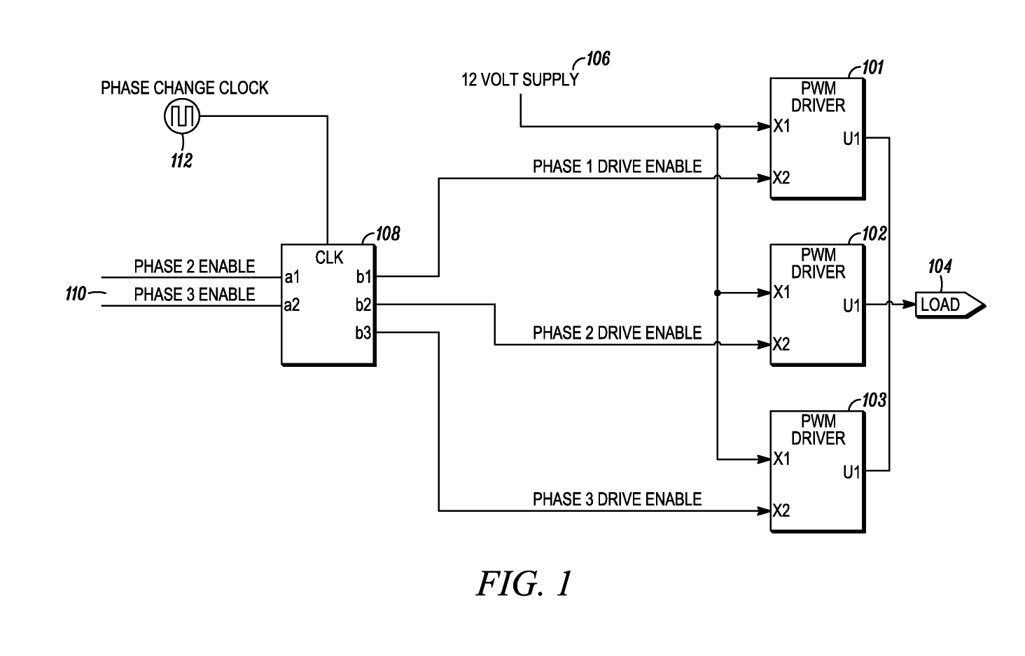

Referring now to FIG. 1, there is shown a block diagram of a multiphase pulse width modulation (PWM) power converter according to one embodiment. The example shown comprises three phases driven by three PWM drivers 101, 102, and 103. Of course in practice more or less phases may be present within the scope of the present invention. Each of the PWM drivers 101, 102, and 103 supply power to a load 104, such as a computing device which may include desktops, servers, and home electronics or mobile computer systems such as laptops, mobile phones, personal digital assistants, tablets, and gaming systems, etc.

A supply voltage source 106 may be provided to each of the PWM drivers 101, 102, and 103. In this example a 12 volt supply is shown, but any other suitable voltage may also be used. A three output latching mechanism 108 may also be used to supply an enable input to each of the PWM drivers. A phase 1 enable signal may be supplied to the first PWM driver 101, a phase 2 enable signal may be supplied to the second PWM driver 102, and a phase 3 enable signal may be supplied to the third PWM driver 103. The three phase drive enable signals may be derived with two phase input signals 110 to the latch 108. The latch 108 may be clocked with a phase change clock 112.

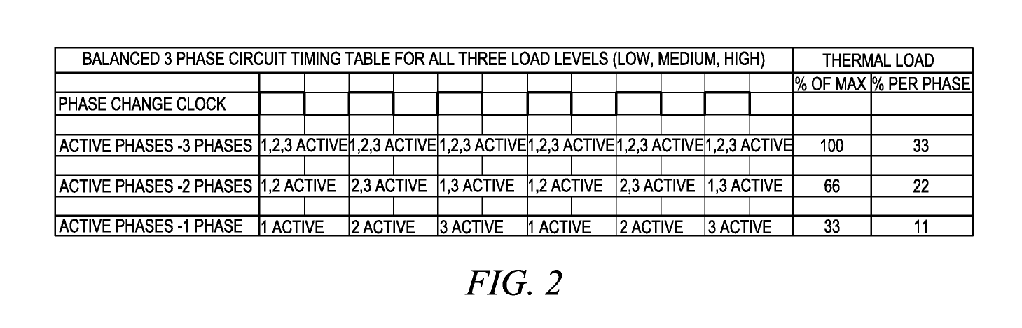

FIG. 2 shows the timing diagram for three different load levels at each cycle of the phase change clock. At 100% load all three phases are active all of the time. Thus, each of the three phases evenly generates approximately 33% of the thermal load.

At a medium load level only two of the three phases are active for a given clock cycle. However, all three phases share the thermal load. That is, during the first clock cycle phase 1 and phase 2 are active, during the second clock cycle phase 2 and phase 3 are active, during the third clock cycle phase 1 and phase 3 are active, and so on. Thus, at medium load the overall converter is operating at approximately 66% of thermal maximum but the thermal load is evenly distributed at 22% for each of the three phases.

At a low level load, only one phase is active for each clock cycle. That is, during the first clock cycle only phase 1 is active. During the second clock cycle only phase 2 is active. During the third clock cycle only phase three is active, and so on. Thus, at low load the overall converter is operating at approximately 33% of thermal maximum but the thermal load is evenly distributed at 11% for each of the three phases. Hence, at for any give load condition, the phases generate heat in a balanced manner.

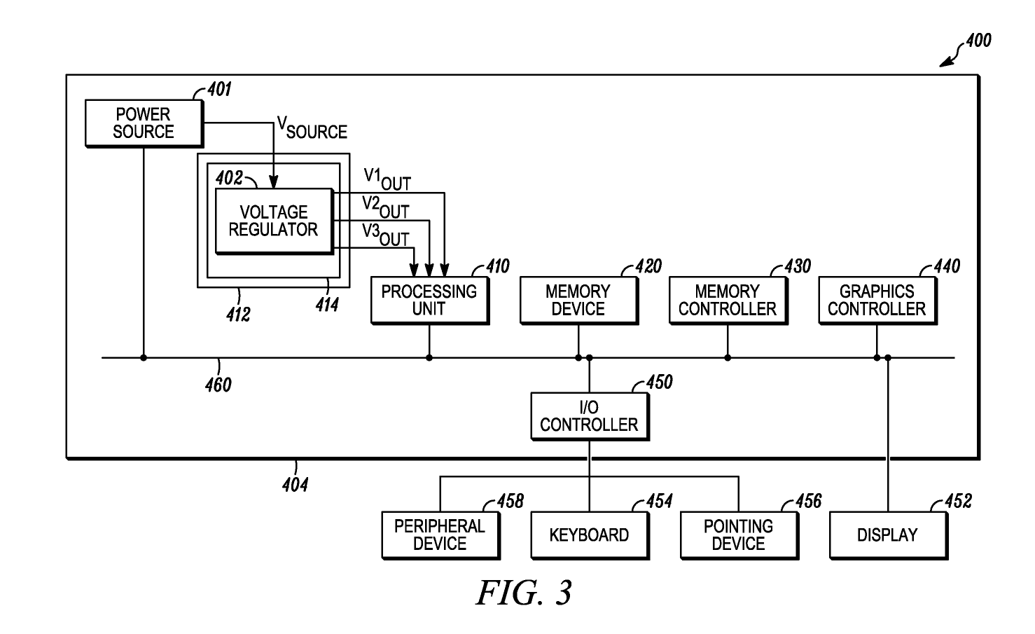

FIG. 3 shows an embodiment of a system 400 including a power source 401 to provide a source voltage V_{SOURCE}, a voltage regulator or converter 402. The voltage regulator may be a thermally balanced regulator as shown in FIG. 1 and operated in a manner shown in FIG. 2. The voltage regulator 402 may receive V_{SOURCE} and provide output voltages V1, V2, and V3. System 400 may also include a processing unit 410, a memory device 420, a memory controller 430, a graphics controller 440, an input and output (I/O) controller 450, a display or touch screen 452, a keyboard 454, a pointing device 456, a peripheral device 458, and a bus 460. System 400 may further include a circuit board 404 on which some components of system 400 are located. FIG. 4 shows an example where V1, V2, and V3, are provided to processing unit 410. In some embodiments, the outputs may be provided to other components of the system 400.

Processing unit 410 may process data transferred to and from other components via bus 460. Processing unit 410 may include a general-purpose processor or an application specific integrated circuit (ASIC). Processing unit 410 may be a single core processing unit or a multiple-core processing unit.

FIG. 3 shows an example where voltage regulator 402 may be included in a single component, for example, voltage regulator 402 may be included in an IC package 412. IC package 412 may include a package substrate 414 coupled to a die on which at least a portion of voltage regulator 402 may be formed on the die. In some embodiments, voltage regulator 402 may be separate multiple components. For example, a portion of voltage regulator 402 may be formed on a die in IC package 412 and the rest of voltage regulator 402 may be outside the die and on circuit board 404. In another example, a portion of voltage regulator 402 may be formed on a die and one or more inductors and capacitors of voltage regulator 402 may be formed on a portion of package substrate 414.

System 400 may include computers (e.g., desktops, laptops, hand-helds, tablets, servers, Web appliances, routers, etc.), wireless communication devices (e.g., cellular phones, cordless phones, pagers, personal digital assistants, etc.), computer-related peripherals (e.g., printers, scanners, monitors, etc.), entertainment devices (e.g., televisions, radios, stereos, tape and compact disc players, video cassette recorders, camcorders, digital cameras, MP3 (Motion Picture Experts Group, Audio Layer 3) players, video games, watches, etc.), and the like.

Thus, according to embodiments, consistently balanced thermal load switched mode converters alternate among all phases of the power switching circuit to provide a uniform temperature rise on all components of the circuit under all load conditions. During low load conditions typically phases are held idle and the load is concentrated on the active phase(s) only, with cooling requirements (air flow, etc.) based on the temperature of the active phase(s). By alternating the active phases in a balanced sequence the thermal load is distributed across all of the phases minimizing system cooling requirements under all load conditions.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
a multiphase power converter having a plurality of phases to supply power to a load;
means for alternately activating and deactivating phases in a balanced sequence during less than 100% power load conditions so that thermal load is evenly distributed across all of the phases to minimizing system cooling requirements under all load conditions.

2. The apparatus as recited in claim 1 wherein the means for alternately activating and deactivating phases in a balanced sequence comprises a latching mechanism with a phase change clock.

3. The apparatus as recited in claim 1 wherein the multiphase power converter comprises at least a first phase, a second phase, and a third phase.

4. The apparatus as recited in claim 3 wherein each of the three phases comprises a pulse width modulation (PWM) driver to supply power to the load.

5. The apparatus as recited in claim 4 wherein at a high power load level phase 1, phase 2, and phase 3 are active during each phase change clock cycle; and
wherein at a medium power load level a different two of the three phases are active during each clock cycle, and
at a low power load level a different one of the three phases are active during each clock cycle.

6. The apparatus are recited in claim 1 wherein the multiphase power converter supplies power to one of a desktop computer, laptop, hand-held, tablet, server, Web appliances, routers, and, wireless communication devices.

7. A method, comprising:
providing a multiphase power converter having a plurality of phases to supply power to a load; and
alternately activating and deactivating phases in a balanced sequence during less than 100% power load conditions so that thermal load is evenly distributed across all of the phases to minimizing system cooling requirements under all load conditions.

8. The method as recited in claim 7 further comprising using a phase change clock and a latching mechanism to alternately activate and deactivate phases in a balanced sequence.

9. The method as recited in claim 7 wherein the multiphase power converter comprises at least a first phase, a second phase, and a third phase.

10. The apparatus as recited in claim 9 further comprising providing a pulse width modulation (PWM) driver for each of the three phases to supply power to the load.

11. The apparatus as recited in claim 10, further comprising:
activating all three phases during each phase change clock cycle during a high power load level;
activating a different two of the three phases during each clock cycle at a medium power load level, and
activating a different one of the three phases during each clock cycle at a low load level.

12. The apparatus are recited in claim 7 wherein the multiphase power converter supplies power to one of a desktop computer, laptop, hand-held, tablet, server, Web appliances, routers, and, wireless communication devices.

13. A system, comprising:
a computing platform;
a multiphase power converter having a plurality of phases to supply power to the computing platform at various load level;
means for alternately activating and deactivating phases in a balanced sequence during less than 100% power load conditions so that thermal load is evenly distributed across all of the phases to minimizing system cooling requirements under all load conditions.

14. The system as recited in claim 13 wherein the means for alternately activating and deactivating phases in a balanced sequence comprises a latching mechanism with a phase change clock.

15. The system as recited in claim 13 wherein the multiphase power converter comprises at least a first phase, a second phase, and a third phase.

16. The system as recited in claim 15 wherein each of the three phases comprises a pulse width modulation (PWM) driver to supply power to the load.

17. The system as recited in claim 15 wherein at a high power load level phase 1, phase 2, and phase 3 are active during each phase change clock cycle; and
wherein at a medium power load level a different two of the three phases are active during each clock cycle, and
at a low power load level a different one of the three phases are active during each clock cycle.

18. The system are recited in claim 13 wherein the computing platform comprises one of a desktop computer, laptop, hand-held, tablet, server, Web appliances, routers, and, wireless communication devices.
